(19) United States
(12) Patent Application Publication
(10) Pub. No.: US 2011/0180103 A1
(43) Pub. Date: Jul. 28, 2011

(54) Multi-Purpose Wet or Dry Cleaning Apparatus

(76) Inventor: Sherri Lynne Haring, Santan Valley, AZ (US)

(21) Appl. No.: 12/794,740

(22) Filed: Jun. 5, 2010

Related U.S. Application Data
(60) Provisional application No. 61/298,392, filed on Jan. 26, 2010.

(51) Int. Cl. B08B 7/00

(52) U.S. Cl. 134/6; 15/209.1

(57) ABSTRACT

The device is a simple system for multipurpose cleaning of difficult areas. This system is comprised of an absorbent cleaning material covering a foamed polymer structure that is attached to a base structure. The fabric collects loose material, provides some abrasive to remove solid deposits, and can be used dry or saturated with a liquid cleaning solution. This cleaning structure, the cleaning material and foamed polymer structure will be attached to a polymer or metallic handle so that a person can reach and clean difficult areas above and below themselves. This handle may be extendable so that any person can reach and adequately clean distant surfaces. This apparatus allows the user to reach and easily clean areas previously overlooked because of difficulty.

### CROSS REFERENCE TO RELATED APPLICATIONS

This application claims the benefit of provisional patent Application No. 61/298,392, filed 2010 Jan. 26 by the present inventor.

### FEDERALLY SPONSORED RESEARCH

Not Applicable

### SEQUENCE LISTING OR PROGRAM

Not Applicable

### BACKGROUND

1. Field

This application relates to general household and commercial cleaning, specifically cleaning difficult to reach places.

2. Prior Art

There are several options for surface cleaning on the market currently; mops, brooms, Swiffer, and hand held cleaning fabric. All of these products work well on flat open areas, but none of these products can easily clean in hard to reach areas like baseboards, behind and around furniture, lighting or decoration fixtures, crown molding, and many other areas.

The Swiffer uses disposable pads to sweep and collect dust and dirt in a small to medium area. These work well for hard flat surfaces where the pad makes continuous contact with the surface, such as flooring. Brooms use a stiff brush-like medium to, like the Swiffer, clear loose material from hard surfaces. Floor Mops, and derivatives of it, use a soft medium to hold water and sanitizer to clean a surface of solid residue. The soft medium helps to clean uneven surfaces, like tile grout lines, and to act as an abrasive on solid residues. Swiffers, brooms, and mops, use a solid extended handle so that a person may extend their reach with, and stand comfortably while using, the product. Hand held cloths, on the other hand, do not have any type of handle. They are a soft medium used to clean solid residue, remove loose material, and change shape to clean uneven and complex shapes other than flooring. These hand held cloths are the most versatile cleaning tool, and the most labor intensive. Without a handle, only surfaces within arm's reach may be cleaned. To reach other surfaces the user must use other tools or go to an uncomfortable position, such as kneeling on hands and knees.

The products listed above are not designed to clean difficult areas like molding and fixtures, and do not ease labor for the average homeowner or professional cleaner. Mops, brooms, and the Swiffer are designed to clean floors, and floors are flat. Common household areas like molding and fixtures are not flat, and cannot be adequately cleaned by floor tools. Other tools, such as microfiber cleaning cloths, terry towels, and hand wash mitts provide a dynamic shape able to clean difficult shapes, but can only clean within arm's reach. Any areas outside of comfortable reaching distance, such as baseboards and fixtures, are difficult to clean with these products.

The problem of adequately cleaning these difficult areas has fallen to intense labor with an incompetent product, there have been no products realized to fully solve this problem. Thus, several advantages of a new product would include ease of cleaning labor in difficult areas, extended reach in cleaning, and ease of cleaning of uneven and dynamic surfaces. These and other advantages will become apparent with consideration of the ensuing description and specification drawings.

### SUMMARY

The device is a simple system for multipurpose cleaning of difficult areas. This system is comprised of an absorbent cleaning material covering a foamed polymer structure that is attached to a base structure. The fabric collects loose material, provides some abrasive to remove solid deposits, and can be used dry or saturated with a liquid cleaning solution. This cleaning structure, the cleaning material and foamed polymer structure will be attached to a polymer or metallic handle so that a person can reach and clean difficult areas above and below themselves. This handle may be extendable so that any person can reach and adequately clean distant surfaces.

### DRAWINGS

Figures

In the drawings, closely related figures pertaining to the same part have the same number but different alphabetic suffixes.

FIGS. 1A and 1B show the head structure to which the soft foamed polymer pad will be attached in one embodiment.

FIGS. 2A and 2B show the foam polymer head, which the cleaning material will cover, that will be attached to the head structure in one embodiment.

FIGS. 3A and 3B show the cleaning material that cover the foamed polymer head in one embodiment.

FIGS. 4A and 4B show a cross section of the cleaning head revealing threads to attach an extendable pole or handle in one embodiment.

FIG. 5 shows an exploded isometric view of the cleaning apparatus, illustrating the assembly structure of the apparatus in one embodiment.

FIG. 6 shows an operational view of the cleaning apparatus, illustrating the flexible nature of the foam polymer head and cleaning material.

### REFERENCE NUMERALS

| | |
|---|---|
| 101 Head Structure | 102 Foamed polymer head mounting point |
| 103 Foamed polymer head support | 104 Head structure handle |
| 105 Head structure threaded base | 201 Foamed polymer head |
| 202 Foamed polymer head mounting point | 301 Cleaning material |
| 302 Cleaning material closure point | 401 Exemplary threaded handle |
| 501 Exemplary Floor and Molding | |

### DETAILED DESCRIPTION

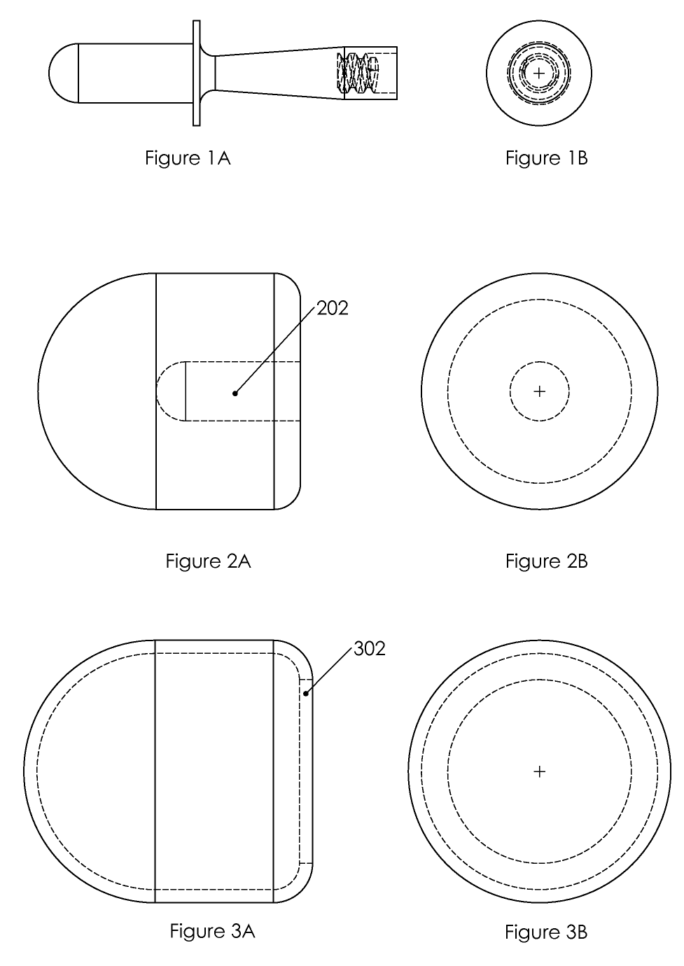

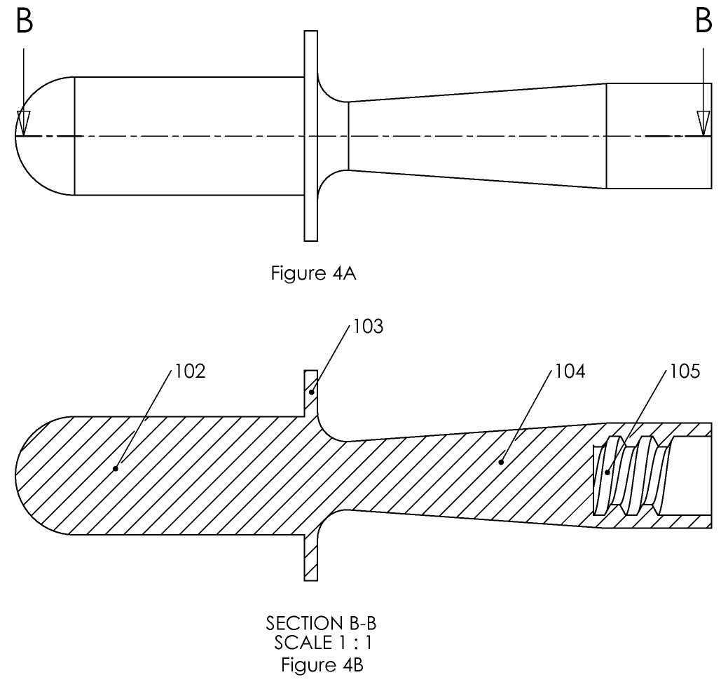

### FIGS. 1,2,3, and 5—First Embodiment

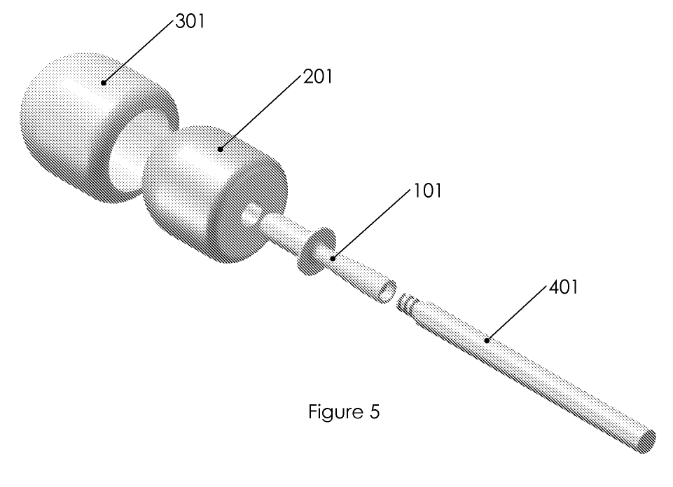

One full embodiment of the cleaning apparatus is shown in FIG. 5 (exploded isometric view). The apparatus features four parts; the base 101, the foam polymer head 201, and the cleaning material 301 are integral while the handle 401 is exemplary. The base 101, also shown in FIGS. 1 and 4, is the main structure of the apparatus. It serves as base mounting point 102 for the foamed polymer head, mounting point 105 for a handle or extendable handle, and functions as a handle 104 when an extension handle is not desired. The foam polymer head support flange 103 provides support to the foam head 201. In the preferred embodiment, the base is a cheap but rigid plastic, such as acrylonitrile butadiene styrene (ABS) or Poly-vinyl-chloride (PVC, hyphens have been inserted to assist with pronunciation). These two materials were selected to provide a cheap yet durable structure to the base; both ABS and PVC have good mechanical properties, chemical resistance, and can be processed in common manufacturing methods.

The base structure should be between 5 inches to 7 inches in length with a 1 inch diameter end 104 to attach to a handle and a 1 inch to 1.5 inch diameter end 102 on which the foam polymer head will mount. All the edges on this piece will be rounded to avoid personal and property damage. The foam polymer mount barrel 102 will have enough surface texture to adequately glue or otherwise attach the foam head 201. The handle end 104 will also feature a common female threading 105 capable of accepting most extendable handles.

At one end of the base structure is the mounting point 102 for the foam polymer head 201 that will provide a support for the cleaning material. The foam polymer head will be glued or otherwise firmly attached to foam mounting point 102 of the base 101. The foam polymer head is a soft foam shape that will support the cleaning material and allow it to form around a variety of shapes. This foam polymer head does not have to be absorbent, it this embodiment the purpose of the foam head is to support and give shape to the cleaning material. The foam polymer head is a synthetic sponge material; Polyurethane or Polyvinyl Alcohol will be suitable to provide support to the cleaning material.

The foam polymer head will be 4 inches to 6 inches in diameter with a mounting hole 202 0.125 inch or 0.25 inch smaller in diameter than base mounting point 102. This will ensure a quality fit between the foam polymer head and the plastic base mounting point.

Over the foam polymer head 201, will fit the cleaning material 301. The cleaning material 301 will be removable from the foam polymer head 201, and will be secured by means of a drawstring, elastic band, clip, or other device 302. The cleaning material 301 will be absorbent to retain and apply cleaning solution, and have some texture to remove contaminates and solid deposits. In this embodiment, the cleaning material 301 will be made of a microfiber or open-end weave microfiber cloth to take advantage of the excellent performance of microfiber in cleaning applications. The cleaning material 301 will be slightly smaller that the foam polymer head 201, to ensure the cleaning material 301 is well supported by the foam polymer head.

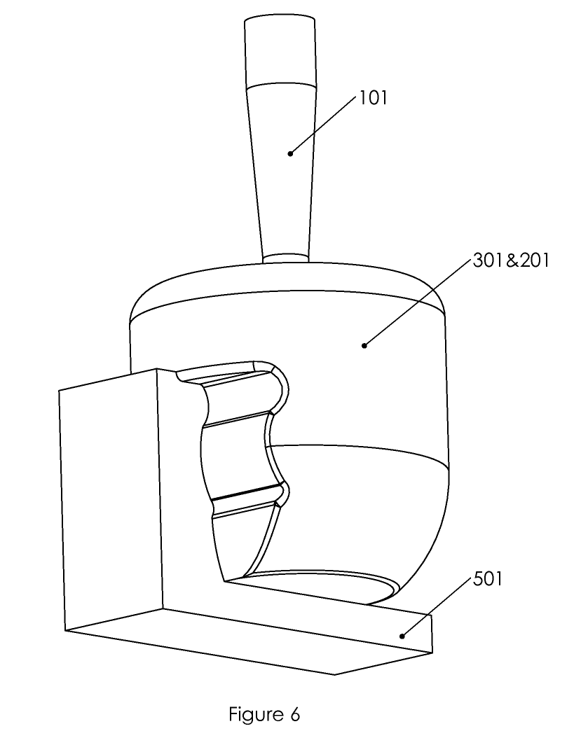

In FIG. 6, the cleaning material 301 over the foam polymer head 201 is shown in operation on an exemplary floor and baseboard molding shape 501. The cleaning material and foam polymer head is shown taking shape to the floor and baseboard molding. In operation, the foam polymer head 201 will support the cleaning material 301 so that the cleaning material may reach and clean surfaces in difficult shapes, styles, and locations. The foam polymer head 201 is attached to the base 101, which adds a support backbone to the foam polymer head, and acts as a handle 104 or an extension handle mounting point 105

I claim:

1) A multi-purpose cleaning apparatus comprising of a polymer head structure, foamed polymer head, cleaning material, and the extension handle.

2) The apparatus of claim 1 wherein the cleaning material cover being absorbent and having texture for absorbing cleaning solution and removing solid deposits.

3) The cleaning material of claim 2 wherein said cleaning material has an adjustable closure.

4) The apparatus of claim 1 wherein said foamed polymer head supports the cleaning material and form fits to irregular surfaces.

5) The apparatus of claim 1 wherein said polymer head structure supports the foamed polymer head.

6) The apparatus of claim 5 wherein said polymer head structure has an axial extrusion to be used as a handle.

7) The apparatus of claim 5 wherein said polymer head structure has internal threads to attach the extension handle.

8) The apparatus of claim 1 wherein said foamed polymer head is attached to the polymer head structure.

9) A method of cleaning difficult to reach areas, comprising:
a) A cleaning material head to absorb liquid cleaning solution.
b) A cleaning material head to be used as an abrasive for the removal of hard deposits.
c) The apparatus of claim 6 wherein the device may be used with an attachable extendable handle
d) The apparatus of claim 1 can be used dry for dusting or sweeping.
e) The apparatus of claim 1 can be used wet for mopping and cleaning heavily soiled surfaces.
